(19) United States
(12) Patent Application Publication
(10) Pub. No.: US 2009/0072944 A1
(43) Pub. Date: Mar. 19, 2009

(54) STREET LIGHTING METHOD AND APPARATUS USING A CHANNEL HOPPING SCHEME FOR A WIRELESS COMMUNICATION BETWEEN A MASTER NODE AND A SLAVE NODE

(76) Inventor: Anthony Hayward, Halifax (GB)

Correspondence Address: KLARQUIST SPARKMAN, LLP, 121 SW SALMON STREET, SUITE 1600, PORTLAND, OR, 97204, US

(21) Appl. No.: 12/280,273

(22) PCT Filed: Apr. 20, 2007
(86) PCT No.: PCT/GB07/01440

§ 371 Date: Aug. 21, 2008

(30) Foreign Application Priority Data
Apr. 20, 2006 (GB) 0607715.0

(51) Int. Cl. G06F 9/00; H04B 1/713

(52) U.S. Cl. 340/2.1; 375/132; 375/E01.033

(57) ABSTRACT

A method and apparatus are disclosed for communicating between a first node and a further node of a communication network via a wireless communication link comprising a plurality of channels. The method includes the steps of generating a pseudo random number at the first node, selecting a one of the plurality of channels responsive to the pseudo random number and transmitting a message from said first node to said further node via the selected channel.

The present invention relates to a method and apparatus for communicating between a first and further node of a communication network via a wireless communication link. In particular, but not exclusively, the present invention relates to a method and system for remotely monitoring and/or controlling street lights dispersed over a wide geographical area via wireless links.

It will be appreciated that in many countries around the world lighting is provided along streets or open areas by large numbers of lamp units. For example, in the UK alone, street lighting infrastructure consists of more than seven million units.

Typically a street light includes a column which is an elongate support at the top of which is supported a housing containing a lamp. The housing may also support a photocell installed in a recess at the top of the street light which can be used to control when the lamp of the street light is illuminated. Power is supplied to the lamp via underground cables connected to electrical connections which pass up the length of the street light column.

Day-to-day operational performance of prior art street lighting systems tend to be monitored on a manual basis, for example, by engineers attending whole streets and/or areas and reporting failure of lamp units in the lights. Alternatively members of the public may be relied upon to inform maintenance crews when a lamp is faulty. Such maintenance is time consuming and costly and is prone to large delays before lamp units are made operational again.

It will be appreciated that in today's energy conscious society there is an increasing demand to be more able to control use of power. Also consumers are becoming more sophisticated in their requirements and therefore there is a continual need to improve the control which can be applied to street lamps so as to be able to turn them on and off at selected times and also determine and control their brightness.

Nevertheless, much of the infrastructure of street lighting networks is already in place. The concept of replacing street lights so as to include more versatile functionality is unattractive since the cost involved may be prohibitive.

It is an aim of the present invention to at least partly mitigate the above-mentioned problems.

It is an aim of embodiments of the present invention to provide a method for communicating between a street light and a control node of a communication system via a wireless communication link so as to enable the street light to be remotely controlled and/or to enable information relating to the operation of the street lamp to be monitored at a remote location.

It is an aim of embodiments of the present invention to provide a wireless communication network which can be utilised to control operation of one or more street lights and which can be relatively simply retro fitted to existing street lighting as well as included in newly installed street furniture.

According to a first aspect of the present invention there is provided a method for communicating between a first node and a further node of a communication network via a wireless communication link comprising a plurality of channels, comprising the steps of:
generating a pseudo random number at said first node;
selecting a one of said plurality of channels responsive to said pseudo random number; and
transmitting a message from said first node to said further node via said selected channel.

According to a second aspect of the present invention there is provided an apparatus for providing a wireless communication network, comprising:
at least one first node comprising a transceiver element; and
a plurality of further nodes each comprising a transceiver element arranged to communicate with said first node via a wireless communication link comprising a plurality of channels; wherein
each first node is arranged to generate a pseudo random number, select one of the channels responsive to the generated number and transmit one or more messages to said further nodes via said selected channel.

Embodiments of the present invention provide a wireless communication network which can be used to communicate with one or more street lights distributed over a large geographical area. The wireless communication is effective over a communication link which includes a plurality of possible channels. Communication between a control node and individual street lamps is carried out over a channel selected according to a pseudo-random number. In this way security of the system can be maintained.

Embodiments of the present invention will now be described hereinafter, by way of example only, with reference to the accompanying drawings in which:

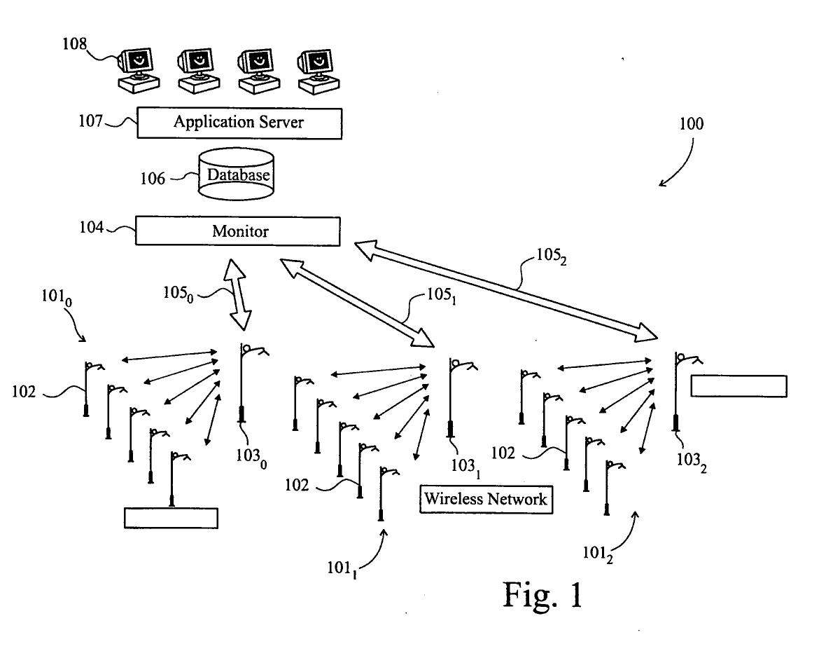

FIG. 1 illustrates a communication network for controlling a plurality of street lights;

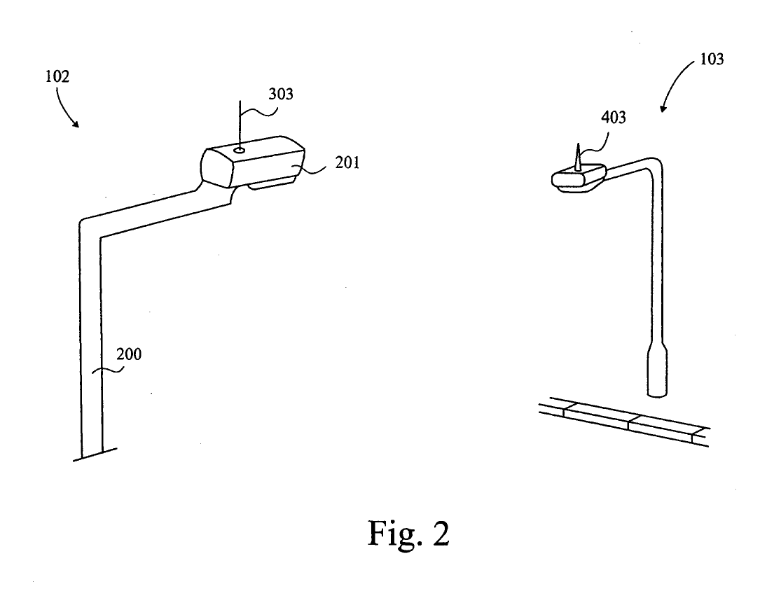

FIG. 2 illustrates a master and slave street light;

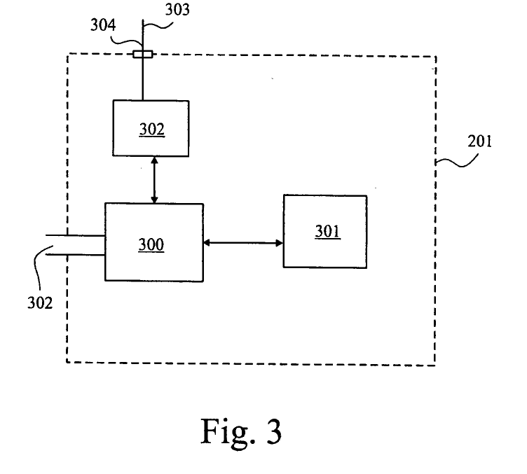

FIG. 3 illustrates a slave node;

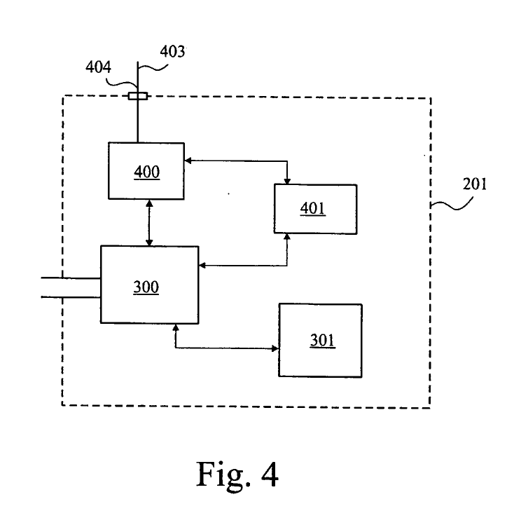

FIG. 4 illustrates a master node;

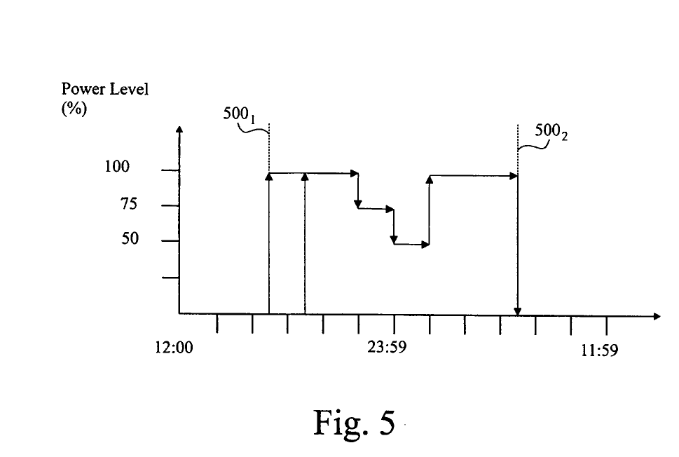

FIG. 5 illustrates a predetermined profile for a street light;

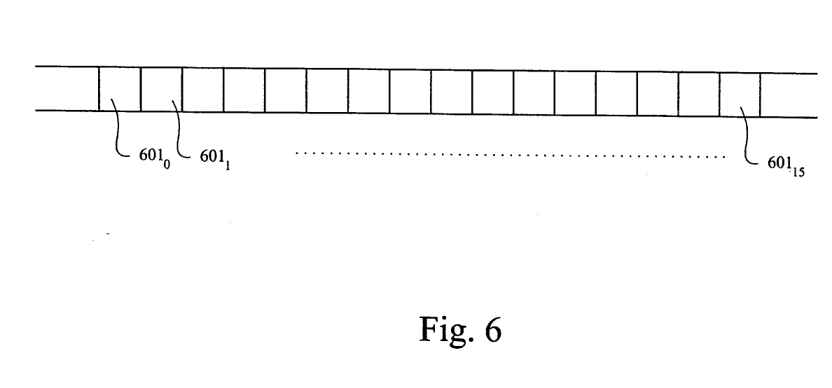

FIG. 6 illustrates channels of a communication link;

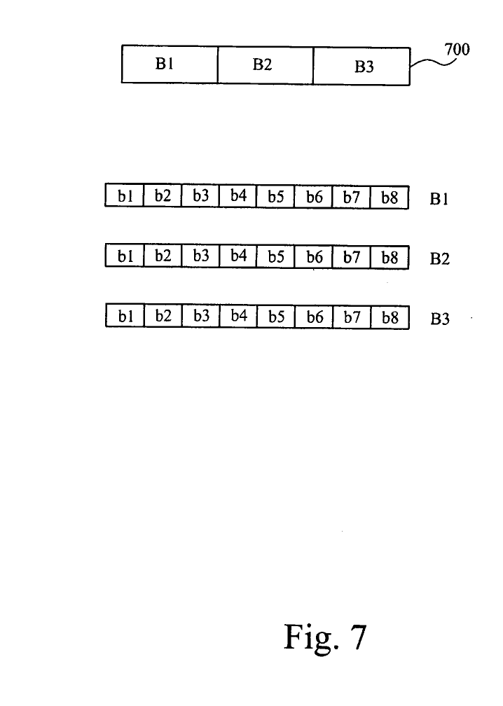

FIG. 7 illustrates a hard coded seed; and

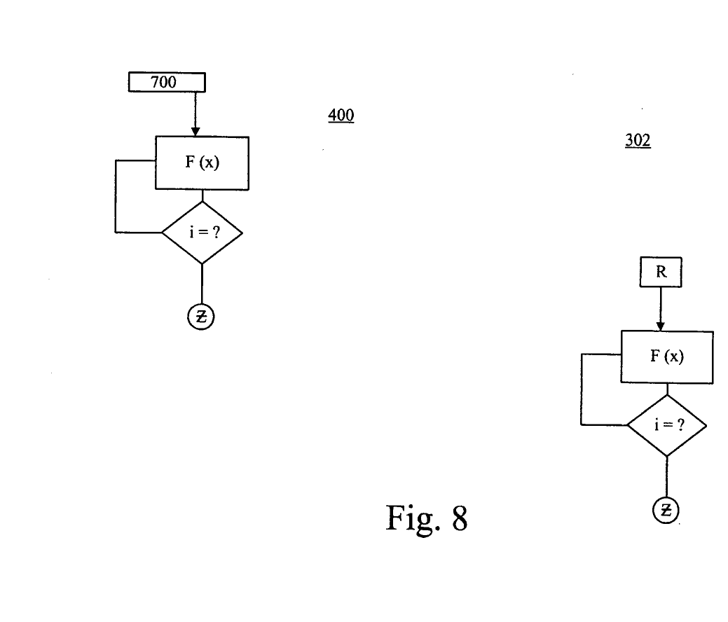

FIG. 8 illustrates generation of a pseudo random number.

In the drawings like reference numerals refer to like parts. In the following description reference is made to communication between a street light and a further node of a communication network. It is to be understood that the term “street light” is to be broadly construed as any lamp unit which may be one of many lamp units distributed over a wide geographical area. For example, a row of street lights set out along a street, but also including multiple lamp units at sports stadia and lighting arranged in an underground rail network.

FIG. 1 illustrates a street light monitoring and control system capable of providing detailed power consumption statistics for use in power consumption billing and for energy usage planning on a lamp level to system wide basis in accordance with an embodiment of the present invention. As noted above, whilst reference is made to the fact that embodiments of the present invention can be used in a street lighting system, it is to be understood that embodiments of the present invention are generally applicable to distributed lighting networks. Such environments offer multiple lamp units distributed over a geographical area where it is advantageous to be able to determine how each individual lamp is functioning or to offer some control via power setting of individual lamps.

As illustrated in FIG. 1, the management system 100 includes separate groups (or clusters) of lamp units 101₀ to 101₂, each of which includes five individual lights 102. It will be understood that each group 101 of street lights 102 can be made up of one to a potentially large number of light units, although five are illustrated by way of example only in FIG. 1 in each group. Each street light 102 communicates via a wireless communication link with a cluster controller 103₀ to 103₂. In this sense the cluster controller 103 operates as a master node which can communicate with each street lamp acting as a slave node. By way of convenience each master controller 103 can be located itself in a street lamp or may be a separate entity such as a base station located sufficiently proximate to the cluster of street lamps so that wireless communication can be performed.

FIG. 2 illustrates a street light 102 forming a slave node and a street light 103 forming a master node in the communication network in more detail. Each street light includes a lamp column 200 which supports a lamp housing 201. The lamp housing contains a lamp such as a discharge lamp as appropriate for the use of the slave node. Power is supplied to the lamp from a street level power source which passes through the column 200 to lamp ballast circuitry. The lamp ballast circuitry can be used to set one of a predetermined number of power settings for the lamp, for example, 0%, 50%, 75% or 100% power. It will be understood that different power settings and a different number of power setting options may be provided. The lamp ballast also includes circuitry to establish some other such lamp characteristic is in place such as when thermal shutdown of a lamp ballast has occurred or when a lamp has failed to strike or a running power level.

FIG. 3 illustrates the contents of the lamp housing 201 in more detail and illustrates how the lamp ballast 300 controls operation of the lamp 301 supplying power which is itself supplied to the lamp ballast from a power line 302 which passes up the lamp column 200.

Each lamp ballast 300 communicates with a bidirectional communication unit 302 which includes an antenna 303 arranged to protrude through an opening in the housing. The opening can be specifically opened in the housing when the monitoring, control and management system is manufactured or retro fitted to existing street lighting. Advantageously, the antenna can be extended through a hole formed when a photocell of an existing housing is removed. A seal 304 is utilised to prevent ingress of water and other contaminants into the lamp housing 201.

Bidirectional communication via a wireless communication link can thus take place between the slave unit 302 and a master node in the wireless communication system.

FIG. 4 illustrates a lamp housing 201 of a master node 103. The housing 201 includes a lamp 301 and lamp ballast 300. The master node includes a bidirectional communication unit 400 to communicate via a wireless communication link to a controller monitoring unit 104. The communication unit 400 includes a GSM modem to contact the monitor 104 via the public wireless phones network. It will be understood that embodiments of the present invention are not restricted to use of a GSM modem. Also in alternative embodiments of the present invention each cluster controller of a master node may be hard wired to the central monitoring unit. The cluster controller 400 includes an associated antenna 403 with associated seal 404. The cluster controller 400 is connected directly to the slave node 401 in each master node 103 when the master node is itself provided in a street light. It will be understood that the functionality of the cluster controller 400 and slave node 401 can be incorporated in a common unit in accordance with embodiments of the present invention.

Each slave unit includes a data store which can be used to store an activation schedule received from higher in the network hierarchy which will determine when a lamp associated with the slave node will be activated and at what level. FIG. 5 illustrates in more detail how an activation schedule can be utilised to control a power level provided to an individual lamp in a street light. A start event 500 which might be a predetermined time being reached or sunrise and/or sunset occurrence. Subsequent to the initiating event 500₁ being determined, the activation schedule indicates a switch on time which may be immediate or some time delay later. Thereafter, over a predetermined period of time, the lamp ballast 300 may be controlled so as to run the lamp at predetermined power levels over predetermined periods of time. The lamp is switched off when the final event 500₂ is reached.

Each slave node can also report conditions from the slave node higher up the network hierarchy to the associated master node. For example, when the lamp ballast associated with each individual slave node reports one or more conditions as noted above, such as thermal shutdown, fail to strike and/or running power level, such conditions can be stored and then communicated to the master node at an appropriate moment.

The master node, which communicates with each slave unit in a cluster, can be used to gather information from each slave node in the cluster and/or forward instructions to each slave node individually. The master node is thus capable of forming a mesh-style network of a predetermined number of slave units. Two hundred and fifty five slave units may be networked to a master node according to the specific embodiment described herein. It will be understood that embodiments of the present invention are not restricted to any particular number of slave units which can be allocated to a master node. Communication between each master and slave node conforms to predetermined wireless standards such as EN300220 Parts 1, 2 and 3, although certain other wireless standards may be adopted.

The monitor tier 104 in the hierarchical structure uses standard communication equipment, terminal servers, modems and mobile phone technology to communicate with each master node disbursed throughout the field. The monitor is thus arranged to communicate via multiple wireless links 105 to the master nodes. Once a connection is established between monitor node and master node, one of a list of exchange messages can be communicated between the monitor and master.

The monitoring node 104 communicates with a relational database 106. The database can be used to store data collected from each street light which is communicated from the street light via a cluster controller to the monitoring node 104 and then to the database. The database can also hold records indicating operation of the slave and master nodes. Such information is communicated from the database to the master and slave nodes via the monitor node 104. The database thus holds records associated with each slave node and master node indicating characteristics associated with each node. These records may indicate one or more of the following: network configuration, lighting equipment configuration (lamp/ballast types), lamp schedules, profiles, lamp activation types (light level, timed, solar clock), fault reports (ballast status data, communications data), calculated power consumption (to minute) and/or possible export data to other MIS/Asset IT systems.

The database 106 may be accessed by a front end application server 107 which is designed to enable general internet web browser system access via one or more user terminals 108. Each user terminal 108 is provided with web browser software packages, such as Firefox or Internet Explorer or others. The browsers can access the application server 107 via a security system including one or more passwords or other verification processes.

In this way users or authorised personnel can log onto the application server 107 and control and/or monitor street lights 102 in the distributed street light system.

It will be appreciated that wireless communication between a street lamp and a potentially adjacent street lamp or proximate street lamp in an urban environment is potentially prone to security risk, for example, unauthorised personnel may wish to take over control of street lamps. In order to help alleviate this problem a channel hopping scheme is adopted whereby communication between a slave node and a master node occurs via a selected channel for a predetermined period of time and then subsequent communication takes place via another channel selected in a highly unpredictable manner. Such channel hopping also provides the advantage that false communication between separate slave nodes and a master node is reduced or avoided entirely. It will be understood that the channel hopping scheme is generally applicable between a first and second node of a communication system connected via a wireless link.

FIG. 6 illustrates a wireless communication link including sixteen possible channels using a frequency division scheme. It will be understood that embodiments of the present invention can make use of wireless communication links divided into multiple channels via other schemes such as code division and/or time division schemes. The wireless communication link is thus formed from a bearer 600 including sixteen separate and distinct slots 601₀ to 601₁₅.

Which of the possible channels is utilised for communication at any particular instance is determined according to a pseudo random code hopping algorithm. In this sense pseudo random means via a process which is extremely difficult to predict. In order to achieve this pseudo random channel hopping algorithm, each master node 103 in the network is provided with a hard coded seed number. This number is programmed into a data store of each master node during manufacture and will thus be stored in the master node 400. FIG. 7 illustrates how a hard coded seed 700 stored at each master node 103 contains three bytes (B1, B2, B3) each of which contains eight bits (61-68).

FIG. 8 illustrates how the hard coded seed 900 is randomised by a mathematical procedure having a function F(x) for a predetermined number of iterations. In this way the pseudo random code which is three bytes long and derived initially by the master node from a hard coded seed embedded within its software or store therein is changed on every transmission by a logical operation. This logical operation is pre-programmed into both the master node and the slave nodes. The procedure is sufficiently simple to be performed in a low-cost 8-bit microcontroller used in each slave node and can be formed using the logical operation of bitwise ANDing, exclusive ORing and/or bit shifts. During initial set up each street lamp is not allocated to a particular master node. When instructions are received from an authorised user setting up the network, these are input at the application server and instructions are thus forwarded to each master node to begin communication with associated slave nodes. Each master node which is arranged to control a cluster of associated slave nodes takes the hard coded seed stored therein and operates on that seed according to a predetermined logical operation for a number of iterations. This number may be preset or may be determined from another source such as one of the bytes of a serial ID associated with that particular master node. When the predetermined number of iterations is complete the output is a pseudo random number Z. This number Z is compared to an internal register which indicates which of the 16 channels the master node should communicate on for that number. Communication then begins for a predetermined period of time using that channel. Slave nodes in the vicinity of the master node will receive this communication and, in addition to messages communicated through the wireless communication link, the pseudo random number Z will be received. In the first instance this number Z will be input as an internal received number R into a data store in each individual slave node.

Each slave node is pre-programmed with the identical pseudo randomising operation F(x) as utilised by the master node. At a predetermined point in time, which can be after each message is received or after a time slot when an expected message should have been received, both the master node 103 and each slave node 102 performs an identical pseudo randomising operation on the random number currently stored. This will generate a new pseudo random number independently at the master node and each slave node. The new pseudo random number is used by the master node to select a next one of the possible channels for further communication. Each slave node also utilises the new pseudo random number which has been internally generated to predict the next communication channel selected by the master node and will hop to that next channel and await receipt of further communication from the master node. When the slave node hops to the next channel and receives a next message from the master node, the message is detected and the pseudo random code being utilised by the master node is decoded and compared with the pseudo random code currently utilised by the slave node. If a match occurs that slave will remain locked on in the code hopping sequence and if that specific message is for that slave node then it will respond with an appropriate response using other data in that message. This response is communicated from the slave node to the master node in a validation message. If the received pseudo random code does not match the pseudo random code being internally generated by the slave node an error has occurred, this message cannot therefore be validated. The slave node will ignore that message. It will then use the code it has generated and in the next time slot it will hop to the next channel it determines is correct. Eventually if a major error has occurred the system will time out after a predetermined number of attempts.

In a similar manner each slave node may be arranged to use the pseudo random code received on a frequency calibration channel (not shown) after performing an automatic frequency calibration procedure to validate that calibration.

Embodiments of the present invention provide a pseudo random channel hopping mechanism between a first and further node in a communication network. Initially only one of the nodes (described herein as the master node) is provided with a predetermined number. This number is in the form of a bit string and conveniently is in the form of three bytes. From this number a further number is generated. The further number is generated by performing one or more logical operations upon the earlier number. The order and type of the logical operations is preset and preknown. The resultant number may then be used by forwarding this in a communication message to the further node or may itself be reinput after iteration whereby the same logical operation will “randomise” the number. The further node (which is described here as the slave node and which in the particular example would be a street light) receives the message from the first node by listening continually to one or more channels of a wireless communication link. When the message is received the pseudo random number utilised at the first node during communication of the message is extracted. At some later point in time, which may be signified by an internal system clock or other method, both the first and further nodes carry out a common logical operation on the current number stored at the respective nodes. Both the first and further nodes thus generate a new pseudo random number. The new pseudo random numbers generated at the first node and the further node should match. Both the first node and the further node compare the whole or part of the new pseudo random number generator with an internal prestored table which links the new number or part of the new number to an associated channel. Communication from the first node then takes place on this channel associated with the new pseudo random number. The further node listens on this channel and will duly receive the new communication. Data may be extracted from the new message such as, for example, the new pseudo random number which may be included in the message and is compared to data stored in the slave node.

In addition to the pseudo random numbers, further messages may be sent between the two nodes on the channel determined by the channel hopping mechanism. Such methods can be used to provide instructions to the slave nodes and/or receive information such as operational parameters from the slave nodes which information is then passed up the hierarchy of the network to be monitored and/or utilised by end users using the browser functionality.

Embodiments of the present invention make use of a random code which helps in authentication so as to improve system security.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A method for communicating between a first node and a further node of a communication network via a wireless communication link comprising a plurality of channels, comprising the steps of:
generating a pseudo random number at said first node;
selecting a one of said plurality of channels responsive to said pseudo random number; and
transmitting a message from said first node to said further node via said selected channel.

2. The method as claimed in claim 1, further comprising the steps of:
providing an initial predetermined number at said first node; and
performing a pseudo randomising operation on the predetermined number at said first node to thereby generate a pseudo random number.

3. The method as claimed in claim 1, further comprising the steps of:
receiving the message at said further node; and
at said further node determining the a pseudo random number from the message.

4. The method as claimed in claim 3, further comprising the steps of:
at said first node and said further node, generating a new pseudo random number by performing a common pseudo randomising operation on the a pseudo random number.

5. The method as claimed in claim 4, further comprising the steps of:
selecting a new one of said plurality of channels responsive to said new pseudo random number.

6. The method of claim 1, further comprising the steps of:
each time said first node communicates with said further node, generating a new pseudo random number and selecting a new one of said plurality of channels on which a message is transmitted to said further node responsive to the new number.

7. The method as claimed in claim 6, further comprising the steps of:
transmitting messages via the wireless communication link from said further node to said first node via a selected channel until a new selected channel is selected at said first node.

8. The method as claimed in claim 2, further comprising the steps of:
performing a pseudo randomising operation by the steps of determining an input number and performing at least one logic operation on said number.

9. The method as claimed in claim 8, further comprising the steps of:
performing four or more logic operations on an input number, said logic operations being selected from the possible logic operations of bit-wise ANDing, exclusive ORing and bit-shifts.

10. The method as claimed in claim 1 wherein said first node comprises a lamp controller node and said further node comprises a street lamp in a communication network arranged for controlling an array of street lamps via one or more lamp controllers.

11. Apparatus for providing a wireless communication network, comprising:
at least one first node comprising a transceiver element; and
a plurality of further nodes each comprising a transceiver element arranged to communicate with said first node via a wireless communication link comprising a plurality of channels;
wherein each first node is arranged to generate a pseudo random number, select one of the channels responsive to the generated number and transmit one or more messages to said further nodes via said selected channel.

12. The apparatus as claimed in claim 11, further comprising:
each first node comprises a memory element arranged to store a predetermined number, and logic circuitry arranged to perform a predetermined set of logic operations on an input number, said set of logic operations comprising a pseudo randomising operation.

13. The apparatus as claimed in claim 11, further comprising:
each further node comprises logic circuitry arranged to perform a predetermined set of logic operations on an input number, said set of logic operations comprising a pseudo randomising operation and said set of logic operations being common to those performed by the logic circuitry of said first node.

14. The apparatus as claimed in claim 11 wherein each further node further comprises:
a lamp;
lamp ballast circuitry; and
a control unit for generating control signals for said lamp ballast circuitry and receiving status signals from said lamp ballast circuitry.

15. The apparatus as claimed in claim 11 wherein each first node further comprises a communication port for receiving data from and transmitting data to a data management node.

16. The apparatus as claimed in claim 15 wherein said first node further comprises:
a lamp;
lamp ballast circuitry; and
a control unit for generating control signals for said lamp ballast circuitry and receiving status signals from said lamp ballast circuitry.

17. (canceled)

18. (canceled)
